(19) United States
(12) Patent Application Publication
(10) Pub. No.: US 2021/0180381 A1
(43) Pub. Date: Jun. 17, 2021

(54) HINGE BLADE STRUCTURE

(71) Applicant: Shandong Meiye Automation Technology Co., Ltd., Liaocheng City (CN)

(72) Inventor: Yulung WU, Liaocheng City (CN)

(21) Appl. No.: 17/157,964

(22) Filed: Jan. 25, 2021

Related U.S. Application Data
(63) Continuation of application No. PCT/CN2019/097023, filed on Jul. 22, 2019.

(30) Foreign Application Priority Data
Jul. 23, 2018 (CN) 201810812063.5
Jul. 23, 2018 (CN) 201810813535.9

(51) Int. Cl. E05F 3/20; E05D 3/02; E05D 11/10; E05F 3/02; E05D 11/08

(52) U.S. Cl. CPC E05F 3/20; E05D 3/02; E05D 11/1028; E05F 3/02; E05D 11/082; E05D 2003/027; E05Y 2800/678; E05Y 2900/148; E05Y 2900/531; E05Y 2900/514; E05D 2011/1092; E05Y 2201/25; E05Y 2201/21; E05Y 2900/132

(57) ABSTRACT

The present disclosure a hinge blade structure comprises two hinge blades, a connection sleeve, a fixed rod, a screw sleeve, a plug, a damping positioning pull rod, and an air cylinder. The damping positioning pull rod and the air cylinder are both disposed in the connection sleeve and disposed between the fixed rod and the plug, the air cylinder is relatively secured to the plug, the damping positioning pull rod is relatively secured to the screw sleeve, the damping positioning pull rod is slidably connected to an inner side of the air cylinder along a length direction of the connection sleeve, the damping positioning pull rod and the air cylinder cooperate to define an air chamber, the air cylinder comprises an air chamber vent through hole and an air inlet, and a resistance force generated between the air chamber and the damping positioning pull rod achieves positioning.

### RELATED APPLICATIONS

This application is a continuation of International Patent Application PCT/CN2019/097023, filed on Jul. 22, 2019, which claims priority to Chinese patent application number 201810813535.9, filed on Jul. 23, 2018, and Chinese patent application number 201810812063.5, filed on Jul. 23, 2018. International Patent Application PCT/CN2019/097023, Chinese patent application number 201810813535.9, and Chinese patent application number 201810812063.5 are incorporated herein by reference.

### FIELD OF THE DISCLOSURE

The present disclosure relates to a connection structure, and in particular relates to a hinge blade structure.

### BACKGROUND OF THE DISCLOSURE

The application number 201210430998.X in the Chinese patent database discloses a positioning hinge device, which cannot adjust the positioning force and self-closing of a hinge blade structure at a preset positioning angle, and the positioning hinge device cannot make the hinge blade structure have a full positioning function. That is, the positioning hinge device cannot make the hinge blade structure have a position function from being in an opening angle (such as 1 degree) to a fully opening angle (such as 180 degrees). An abutment spring in a mounting groove of the positioning hinge device can not adjust its stored elastic force. If the above-mentioned positioning hinge is used frequently, the spring's stored elastic force will be weakened, which will weaken the spring against the positioning bead, and relatively make the positioning hinge lose its positioning function. The applicability is limited.

### BRIEF SUMMARY OF THE DISCLOSURE

In order to overcome deficiencies of the existing techniques, the present disclosure provides a hinge blade structure to solve the technical problems of the background.

A first technical solution of the present disclosure is as follows.

A hinge blade structure comprises two hinge blades, a connection sleeve, a fixed rod, a screw sleeve, a plug, a damping positioning pull rod, and an air cylinder. Each hinge blade of the two hinge blades comprises a shaft sleeve and a blade secured to an outer side of the shaft sleeve, the shaft sleeves of the two hinge blades at least partially encompass the connection sleeve to enable the two hinge blades to be configured to rotate relative to each other, the fixed rod and the plug are connected to an inner side of the connection sleeve, the fixed rod is separated from the plug, the fixed rod and the plug are respectively and relatively secured to the shaft sleeve of one hinge blade of the two hinge blades, the screw sleeve is disposed in the connection sleeve and disposed between the fixed rod and the plug, the fixed rod comprises a screw rod, the screw rod is screwed to the screw sleeve, the damping positioning pull rod and the air cylinder are both disposed in the connection sleeve and disposed between the fixed rod and the plug, the air cylinder is relatively secured to the plug, the damping positioning pull rod is relatively secured to the screw sleeve, the damping positioning pull rod is slidably connected to an inner side of the air cylinder along a length direction of the connection sleeve, the damping positioning pull rod and the air cylinder cooperate to define an air chamber, the air cylinder comprises an air chamber vent through hole and an air inlet, and a resistance force generated between the air chamber and the damping positioning pull rod achieves positioning.

A second technical solution of the present disclosure is as follows.

A hinge blade structure comprises two hinge blades, a connection sleeve, a fixed rod, a screw sleeve, a plug, a damping positioning pull rod, an air cylinder, and an adjusting base. Each hinge blade of the two hinge blades comprises a shaft sleeve and a blade secured to an outer side of the shaft sleeve, the shaft sleeves of the two hinge blades at least partially encompass the connection sleeve to enable the two hinge blades to rotate relative to each other, the fixed rod and the plug are connected to an inner side of the connection sleeve, the fixed rod is separated from the plug, the fixed rod and the plug are respectively and relatively secured to the shaft sleeve of one hinge blade of the two hinge blades, the screw sleeve is disposed in the connection sleeve and disposed between the fixed rod and the plug, the fixed rod comprises a screw rod, the screw rod is screwed to the screw sleeve, the damping positioning pull rod and the air cylinder are both disposed in the connection sleeve and disposed between the fixed rod and the plug, the air cylinder is relatively secured to the plug, the damping positioning pull rod is relatively secured to the screw sleeve, the damping positioning pull rod is slidably connected to an inner side of the air cylinder along a length direction of the connection sleeve, the damping positioning pull rod and the air cylinder cooperate to define an air chamber, the air cylinder comprises an air chamber vent through hole, the adjusting base is movably connected to the plug, a size of a gap disposed between the adjusting base and the air chamber vent through hole, a resistance force between the air chamber and the damping positioning pull rod, and positioning force of the hinge blades are configured to be adjusted due to a relative movement between the adjusting base and the air chamber.

Compared with the existing techniques, the technical solution has the following advantages.

The present disclosure further comprises a damping positioning pull rod and an air cylinder. The damping positioning pull rod and the air cylinder cooperate to form an air chamber. The air cylinder is provided with an air chamber vent through hole and an air inlet. Positioning is generated through resistance of the air chamber relative to the damping positioning pull rod so as to achieve in a whole process.

The size of the gap between the adjusting base and the air chamber vent through hole, the resistance of the air chamber relative to the damping positioning pull rod and the positioning force of the hinge in a preset position can be adjusted through the relative movement of the adjusting base and the air cylinder.

### BRIEF DESCRIPTION OF THE DRAWINGS

FIG. 1 illustrates an exploded perspective view of a hinge of Embodiment 1.

FIG. 2 illustrates a perspective view of an upper circlip of Embodiment 1.

FIG. 3 illustrates a perspective view of a screw hole of a screw sleeve of Embodiment 1.

FIG. 4 illustrates a perspective view of a screw hole thread of the screw sleeve of Embodiment 1.

FIG. 5 illustrates a perspective view of a damping positioning pull rod of Embodiment 1.

FIG. 6 illustrates a perspective view of a plug of Embodiment 1.

FIG. 7 illustrates a perspective view of a second sealing rubber ring of Embodiment 1.

FIG. 8 illustrates a perspective view of a third sealing rubber ring of Embodiment 1.

FIG. 9 illustrates a sectional perspective view of the plug of Embodiment 1.

FIG. 10 illustrates an exploded perspective view of a hinge of Embodiment 2.

FIG. 11 illustrates a sectional perspective view of an air cylinder of a plug of Embodiment 2.

FIG. 12 illustrates an exploded perspective view of a hinge of Embodiment 3.

FIG. 13 illustrates a sectional perspective view of an air cylinder of a plug of Embodiment 3.

FIG. 14 illustrates an exploded perspective view of a hinge of Embodiment 4.

FIG. 15 illustrates an exploded perspective of a hinge of a vehicle of Embodiment 5.

FIG. 16 illustrates a sectional perspective view of a high hermetical hinge of Embodiment 6.

FIG. 17 illustrates a perspective view of a vertical protruding seat of a second hinge blade of Embodiment 6.

FIG. 18 illustrates a perspective view of a first hinge blade of Embodiment 6.

FIG. 19 illustrates a perspective view of a plug of Embodiment 6.

FIG. 20 illustrates an exploded perspective of a hinge of Embodiment 7.

FIG. 21 illustrates an exploded perspective of a hinge of Embodiment 8.

FIG. 22 illustrates a sectional perspective view of a damping positioning pull rod of Embodiment 8.

FIG. 23 illustrates an exploded perspective view of a hinge of a vehicle of Embodiment 9.

### DETAILED DESCRIPTION OF THE EMBODIMENTS

### Embodiment 1

A structure configured to adjust a positioning force of a blade of a hinge in a whole process directions can be disposed in a shaft sleeve of a butterfly hinge, an H-shaped hinge, a son-and-mother shaped hinge, a flag-shaped hinge, and any particular hinge, so that the hinge can be disposed in any door and window. The door hinge blades and the door blade can adjust a positioning force of the hinge blades positioned between a 1° opening angle of the hinge blades and a 180° opening angle of the hinge blades.

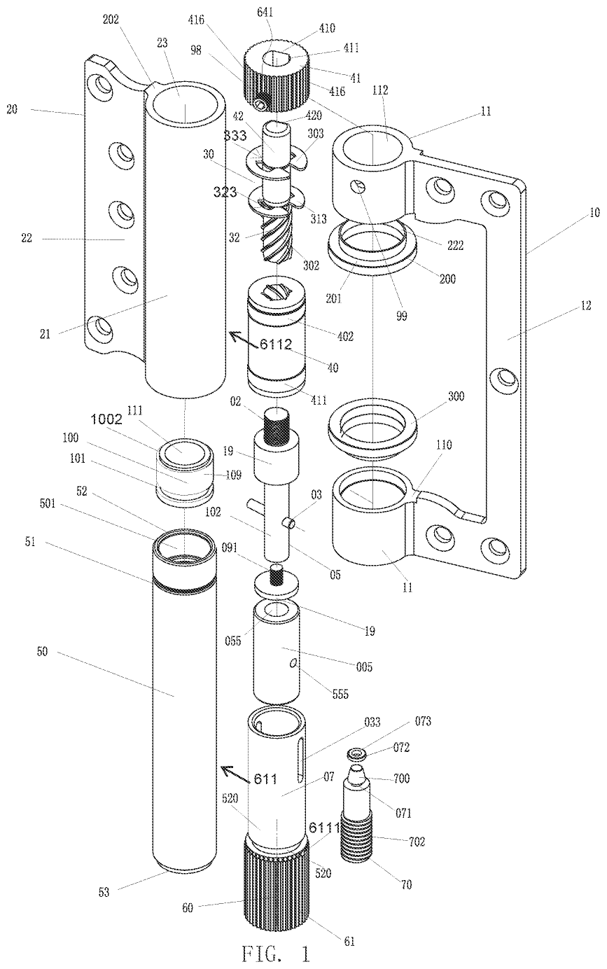

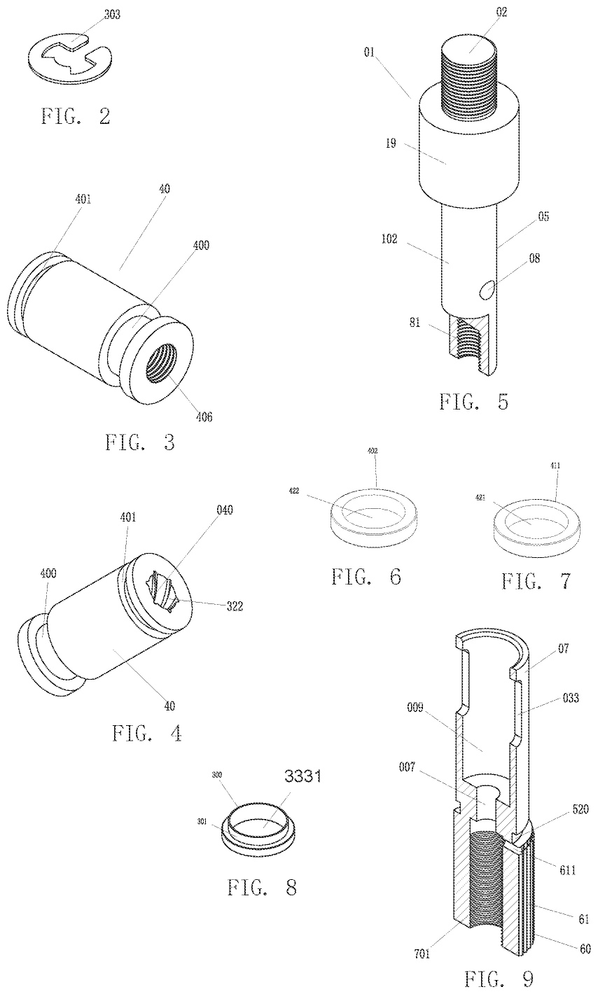

Referring to FIGS. 1-9, the hinge comprises a first hinge blade 10 and a second hinge blade 20; the first hinge blade 10 is provided with a first blade 12 and two first shaft sleeves 11 secured to the first blade 12 at intervals, and the first blade 12 comprises an opening; the second hinge blade 20 is disposed with a second shaft sleeve 21 and a second blade 22 secured to the second shaft sleeve 21; the second shaft sleeve 21 is disposed between the two first shaft sleeves 11 disposed on upper and lower sides, the second blade 22 cooperates with the opening of the first blade 12 to define an up and down alignment, so that the two first shaft sleeves 11 are configured to rotate relative to an axis of the second shaft sleeve 21 in a preset rotation angle of the first blade 12.

The hinge also comprises a connection sleeve 50, a fixed rod 30, a screw sleeve 40, a damping positioning pull rod 01, an air cylinder 07, a first bearing 100, a second bearing 200, a third bearing 300, a plug 60, and an adjusting base 70.

The fixed rod 30 comprises a transmission rod 42, an upper annular circlip groove 333 and a lower annular circlip groove 323 are circumferentially disposed on an outer ring of the transmission rod 42, a swivel ring 41 cooperates with and is secured to an inner ring 112 of an upper shaft sleeve of the two first shaft sleeves 11, and the swivel ring 41 is disposed on an upper end of the inner ring 112 of the two first shaft sleeves 11. In a specific structure: an outer ring of the swivel ring 41 is circumferentially disposed with a swivel ring roll wreath 416, and the swivel ring roll wreath 416 is encompassed in the inner ring 112 of the upper shaft sleeve due to interference fit, so that the swivel ring 41 is secured to the inner ring 112 of the upper shaft sleeve; a cut plate side 420 of a side surface of the outer ring of the transmission rod 42 cooperates with a cut plate side 410 of an inner ring of an inner hole of the swivel ring 41, and a fixed screw 98 is screwed to and passes through shaft sleeve screw hole 99 of the upper shaft sleeve and is then locked to and passes through the swivel ring 41 and is then locked to and is secured to the transmission rod 42, so that the two first shaft sleeves 11, the swivel ring 41, and the transmission rod 42 are secured together, and an axial direction and a distance position of a wheelbase that the screw sleeve 40 axially slides and moves relative to the screw rod 32 up and down is positioned and restricted.

The transmission rod 42 passes through a bearing inner hole 111 of the first bearing 100 and a swivel ring inner annular hole 411 of the swivel ring 41, and is rotatably connected to the bearing inner annular hole 111, the swivel ring inner annular hole 411, and an inner ring 501 of the connection sleeve 50 without movement. An upper circlip 303 cooperates with and is disposed on the upper annular circlip groove 333 of the fixed rod 30, is snapped in the upper annular circlip groove 333, and abuts an end surface of the first bearing 100; a lower circlip 313 cooperates with and is disposed on the lower annular circlip groove 323 of the fixed rod 30, is snapped in the lower annular circlip groove 323, and abuts the other end surface of the first bearing 100. The fixed rod 30 is prevented from sliding and moving up and down and moving due to the upper circlip 303 and the lower circlip 313; the swivel ring 41 is secured to a portion of the transmission rod 42 extending out of the first bearing 100.

A portion of the plug 60 extending out of the connection sleeve 50 cooperates with and passes through a shaft sleeve inner ring (i.e., an inner hole of the inner ring 112 of a lower shaft sleeve of the two first shaft sleeves 11), so that the plug 60 is connected to the two first shaft sleeves 11, and the screw sleeve 40 is separated from the plug 60; the screw sleeve 40, the damping positioning pull rod 01, and the adjusting base 70 are disposed between the fixed rod 30 and the plug 60 disposed in the shaft sleeves (i.e., the two first shaft sleeves 11 and the second shaft sleeve 21) of the two hinge blades (i.e., the first hinge blade 10 and the second hinge blade 20). The connection sleeve 50 cooperates with and is encompassed in a shaft sleeve inner ring 202 of the second shaft sleeve 21 and the shaft sleeve inner rings 112 of the two first shaft sleeves 11; a bearing inner ring 111 (i.e., the bearing inner hole 111) of the first bearing 100 is configured to rotate, while a bearing base 109 of the first bearing 100 is encompassed in and is secured to an end of the connection sleeve 50 without rotation and movement. A bearing inner hole 222 of the second bearing 200 rotatably cooperates with and encompasses the connection sleeve 50, a bearing protruding ring 201 of an end surface of the second bearing 200 cooperates with and is encompassed in the hole of the inner ring 112 of the upper shaft sleeve, the end surface of the second bearing 200 is configured to abut a circumferential end surface 110 of the two first shaft sleeves 11, and the other end surface of the second bearing 200 is configured to abut a shaft sleeve circumferential end surface 202 of the second shaft sleeve 21; a bearing inner hole 3331 of the third bearing 300 rotatably cooperates with and encompasses the plug 60, and a protruding ring 301 of an end surface of the third bearing 300 cooperates with and is encompassed in the hole the inner ring 112 of the lower shaft sleeve, and one end surface of the third bearing 300 is configured to abut a circumferential end surface 110 of the two first shaft sleeves 11, and the other end surface of the third bearing 300 is configured to abut the shaft sleeve circumferential end surface 202 of the second shaft sleeve 21, so that the first hinge blade 10 can rotate about an axis of the second hinge blade 20 more smoothly.

The transmission rod 42 is rotatably connected to an inner side of the connection sleeve 50 without movement. The swivel ring 41 disposed in the two first shaft sleeves 11 is secured to the fixed rod 30 to prevent an axial movement of the fixed rod 30. The inner ring 501 of the connection sleeve 50 comprises a third flange 53, and the third flange 53 is configured to abut an inner side of an annular groove 520 of the plug 60 in the connection sleeve 50 to enable the third flange 53 to be embedded in the annular groove 520 of the plug 60 in the connection sleeve 50, so that the plug 60 is secured to the third flange 53 in the connection sleeve 50. A portion of the plug 60 extending out of the inner ring 501 of the connection sleeve 50 passes through the hole of the inner ring of the two first shaft sleeves 11. The fixed rod 30 comprises a screw rod 32. A screw thread 302 of screw rod 32 of the fixed rod 30 cooperates and is screwed to a screw hole thread 322 of the screw sleeve 40, which is configured to limit a distance position that the damping positioning pull rod 01 slides and moves downward along an axis of an air chamber 009 in the air cylinder 07, so that the blades of the hinge can be positioned in a whole process.

An end of the air cylinder 07 is disposed with the air chamber 009, and a bottom end surface of an inner ring of the air chamber 009 comprises an air chamber vent through hole 007; an adjusting base protruding valve 700 is disposed on a front annular end surface of the adjusting base 70. A diameter and a taper degree of the adjusting base protruding valve 700 protrudes from large to small and cooperates with the air chamber vent through hole 007. The adjusting base protruding valve 700 of the adjusting base 70 is configured to cooperate with the adjusting base 70, so that the adjusting base 70 is configured to be adjusted and rotated by external force to correspond with the plug 60, the air cylinder 07, the damping positioning pull rod 01, and the screw sleeve 40, so as to adjust a gap size between the adjusting base protruding valve 700 of the adjusting base 70 and the air chamber vent through hole 007, to adjust a discharge volume and an intake volume of the air chamber vent through hole 007, to adjust a pressure of an air source, a value of a compression ratio pressure of the high pressure suction-expiration air source, and a pressure intensity in the air cylinder 07 and the air chamber 009 generated by the damping positioning pull rod 01 hermetically disposed in the air cylinder 07 and the air chamber 009, to adjust the pressure of the air source, the value of the compression ratio pressure of the high pressure suction-expiration air source, and the pressure intensity in the air cylinder 07 and the air chamber 009 generated by the damping positioning pull rod 01 and the first sealing rubber ring 005 of the damping positioning pull rod 01, to adjust a frictional damping positioning force generated by the first sealing rubber ring 005 of the damping positioning pull rod 01 in the air cylinder 07 and the air chamber 009, to adjust the hinge blades to be positioned between a 1° opening angle of the hinge blades and a 180° opening angle of the hinge blades and the adjusting base 70 can adjust a positioning force of the hinge blades at any angle. For example, to enable the hinge blades to be positioned between the 1° opening angle of the hinge blades and the 180° opening angle of the hinge blades, and to enable the first blade 12 to be positioned in the whole process.

An annular mounting groove 071 is circumferentially disposed on the outer ring of the adjusting base protruding valve 700 of the adjusting base 70, and a hole 073 of an inner ring of a fourth sealing rubber ring 072 of the adjusting base protruding valve 700 cooperates with and encompasses an inner side of an ring mounting groove 071 of the adjusting base 70, the fourth sealing rubber ring 072 further extends out of the annular mounting groove 071 of the adjusting base 70, and a diameter of the fourth sealing rubber ring 072 is larger than a diameter of the air chamber vent through hole 007, the adjusting base protruding valve 700 is configured to be hermetically slidably connected to and abut the inner side of the air chamber vent through hole 007, so that the adjusting base protruding valve 700 of the adjusting base 70 can cooperate with the adjusting base 70. Compressed gas of the gas source extruded by high pressure generated due to the damping positioning pull rod 01 and the first sealing rubber ring 005 sliding and moving up and down in the air cylinder 07 and the air chamber 009 is discharged through the air chamber vent through hole 007 and a plug vent through hole 6111; and compressed gas of the air source sucked by high pressure suction generated due to the damping positioning pull rod 01 and the first sealing rubber ring 005 sliding and moving up and down in the air cylinder 07 and the air chamber 009 is sucked into the air chamber 009 through the plug vent through hole 6111 and the air chamber vent through hole 007 at high pressure. The air chamber vent through hole 007 and the plug vent through hole 6111 are mutually in communication and are in communication with the air source. Left and right sides of a circumferential periphery of the inner ring and the outer ring of the air cylinder 07 are aligned and are disposed with sliding rod through holes 033, and an end of the damping positioning pull rod 01 is disposed with a positioning pull rod connection rod 102, and a circumferential periphery of an outer ring of the positioning pull rod connection rod 102 is disposed with a positioning pull rod through hole 08, and a sliding rod 03 passes through the sliding rod through holes 033 of the air cylinder 07 and the positioning pull rod through hole 08, so that the sliding rod 03 is configure to be secured to the positioning pull rod through hole 08 of the damping positioning pull rod 01. However, the sliding rod 03 abuts the sliding rod penetration holes 033 disposed on the left and right sides of the circumferential periphery of the inner ring and the outer ring of the air cylinder 07, positions of the sliding rod through holes 033 disposed on the left and right sides of the circumferential periphery of the inner ring and the outer ring of the air cylinder 07 are aligned, so that the sliding rod 03 is configured to position and limit distance, size, and the axial direction and the distance position of the wheelbase that the screw sleeve 40 and the damping positioning pull rod 01 slide and move up and down to be not changed, to enable the axial direction and the distance position of the wheelbase that the screw sleeve 40 drives the damping positioning pull rod 01 to axially slide and move relative to the screw rod 32 of the fixed rod 30 to be not changed, to enable the damping positioning pull rod 01 and the first sealing rubber ring 005 of the damping positioning pull rod 01 to axially slide and move in the air cylinder 07 and the air chamber 009 to generate a strong frictional damping positioning force in the air cylinder 07 and the air chamber 009, and to enable the first blade 12 of the first hinge blade 10 to be positioned in all way. An end of the air cylinder 07 is secured to the plug 60.

An inner diameter of the inner ring of the air cylinder 07 cooperates with diameters of protruding rings 19 disposed on two ends of the damping positioning pull rod 01, and a diameter of the first sealing rubber ring 005 of the damping positioning pull rod 01 is larger than a diameter of the inner ring of the air cylinder 07. The first sealing rubber ring 005 further extends out of a pull rod annular mounting groove 05, and further extends out of the diameters of the protruding rings 19 disposed on two ends of the damping positioning pull rod 01, so that the first sealing rubber ring 005 disposed on the damping positioning pull rod 01 is configured to strongly abut a wall of the inner ring of the air cylinder 07, the damping positioning pull rod 01 is configured to hermetically and slidably abut the inner side of the air cylinder 07, the damping positioning pull rod 01 and the screw sleeve 40 axially slide and move relative to the screw rod 32 of the fixed rod 30, the damping positioning pull rod 01 generates frictional damping force and frictional resistance force in the air cylinder 07, and the first blade 12 is entirely configured to be positioned during an opening process.

The damping positioning pull rod 01 protrudes to define a positioning pull rod connection rod 102, and a first protruding ring 19 disposed on the damping positioning pull rod 01 and a second protruding ring 19 screwed on a pull rod screw hole 81 of the positioning pull rod connection rod 102 are configured to define the pull rod annular mounting groove 05, and after a sealing rubber ring inner hole 055 of the first sealing rubber ring 005 cooperates with and encompasses the pull rod annular mounting groove 05 of the positioning pull rod connection rod 102, a screw rod 091 of the second protruding ring 19 is screwed in the pull rod screw hole 81, so that the screw rod 091 of the second protruding ring 19 is configured to be secured to the positioning pull rod connection rod 102 of the damping positioning pull rod 01.

One end surface of the damping positioning pull rod 01 is disposed with a connecting screw rod 02, and the connecting screw rod 02 is adapted to be screwed into a screw sleeve screw hole 406 of the screw sleeve 40, so that the damping positioning pull rod 01 is secured to the screw sleeve 40 to enable the damping positioning pull rod 01 and the screw sleeve 40 to axially slide and move relative to the screw rod 32. The other end surface of the damping positioning pull rod 01 is disposed with a positioning pull rod connection rod 102.

A front surface of an end of the positioning pull rod connection rod 102 comprises the pull rod screw hole 81, and the sealing rubber ring inner hole 055 of the sealing rubber ring 005 cooperates with and encompasses the pull rod annular mounting groove 05 of the positioning pull rod connection rod 102, one end surface of the second protruding ring 19 is disposed with the screw rod 091, so that an annular groove disposed between the protruding ring 19 disposed on the one end surface of the damping positioning pull rod 01 and the protruding ring 19 disposed on the other end surface of the damping positioning pull rod 01 is configured to define the pull rod annular mounting groove 05, and the protruding ring 19 disposed on the one end surface of the damping positioning pull rod 01 and the protruding ring 19 disposed on the other end surface of the damping positioning pull rod 01 are configured to enable the first sealing rubber ring 005 to be secured and limit a displacement and a separation of the first sealing rubber ring 005. A circumferential periphery of the outer ring of the first sealing rubber ring 005 comprises a rubber ring through hole 555, and the sliding rod 03 cooperates with the rubber ring through hole 555.

A circumferential periphery of the outer ring of the screw sleeve 40 comprises an annular mounting groove 401 and an annular mounting groove 400; a second sealing rubber ring inner hole 422 of a second sealing rubber ring 402 cooperates with and encompasses the annular mounting groove 401, a diameter of the second sealing rubber ring 402 further protrudes out of the annular mounting groove 401, and the diameter of the second sealing rubber ring 402 is larger than the inner diameter of the inner ring of the connection sleeve 50, so that the screw sleeve 40 is configured to hermetically and slidably abut the wall of the inner ring 501 of the connection sleeve; and a third rubber ring inner hole 421 of a third sealing rubber ring 411 cooperates with and encompasses the annular mounting groove 400, a diameter of the third sealing rubber ring 411 further extends out of the annular mounting groove 400, so that the screw sleeve 40 is configured to hermetically and slidably abut the wall of the inner ring 501 of the connection sleeve, the second sealing rubber ring 402 disposed in the annular mount groove 401 of the screw sleeve 40 and the third sealing rubber ring 411 disposed in the annular mounting groove 400 are configured to cooperate with the screw sleeve 40 disposed in the connection sleeve 50 to axially slide and move relative to the screw rod 32.

When the two hinge blades rotate relative to each other, the screw sleeve 40 and the screw rod 32 disposed in the two shaft sleeves can rotate relative to each other, so that the screw sleeve 40 and the damping positioning pull rod 01 are configured to axially slide and move relative to the screw rod 32 within a preset positioning angle of the hinge rotation. The first blade 12 is opened from a right side by external force, so that the first blade 12 is configured to drive the transmission rod 42 disposed in the two first shaft sleeves 11 and the screw rod 32 disposed in the second shaft sleeve 21 to rotate. However, as needed, a size and a tooth pitch of a screw rod reverse screw thread of the fixed rod 30 cooperates with a screw sleeve reverse screw thread of the screw sleeve 40, parameters should be selected to cooperate with each other, the axial direction and the distance position of the wheelbase that the screw sleeve 40 and the damping positioning pull rod 01 axially slide and move relative to the screw rod 32 is preset and restricted, so that the screw sleeve 40 and the damping positioning pull rod 01 are configured to axially slide downward relative to the screw rod 32 within a preset rotation positioning angle of the hinge blade, the damping positioning pull rod 01 and the first sealing rubber ring 005 disposed on the damping positioning pull rod 01 enters into the air chamber 009 disposed in the air cylinder 07. At the same time, the damping positioning pull rod 01 and the first sealing rubber ring 005 disposed on the damping positioning pull rod 01 are disposed in the air camber 009 disposed in the air cylinder 07 to generate relatively large frictional damping positioning force, so as to enable the first blade 12 to generate a positioning force in the whole process. At the same time, the first blade 12 is opened at any angle between a 1° positioning angle and a 180° positioning angle to be positioned, at the same time, the adjusting base 70 can be adjusted and be rotated to adjust the gap between the adjusting base protruding valve 700 and the air chamber vent through hole 007 due to the external force, to enable the first blade 12 of the first hinge blade 10 opened at from 1° angle to 180° angle to generate positioning force.

In some embodiments, one end of the inner ring 501 and the outer ring of the connection sleeve 50 protrude to define a first flange 51, and the inner ring 501 and the first flange 51 are configured to abut an inner side of the annular groove 101 of the first bearing 100 in the connection sleeve 50, so that the inner ring 501 and the first flange 51 are configured to be embedded in the annular groove 101 of the first bearing 100 in the connection sleeve 50, and the first bearing 100 and the first flange 51 are secured to the connection sleeve 50 and are disposed in the connection sleeve 50. An upper end of the connection sleeve 50 protrudes inward to define a second flange 52, and the second flange 52 is configured to abut an annular groove 1002 of the first bearing 100, so that the second flange 52 is configured to be embedded in the annular groove 1002 of the first bearing 100 in the inner ring 501 of the connection sleeve 50, the first bearing 100 and the second flange 52 are configured to be secured in the connection sleeve. An outer peripheral wall of the connection sleeve 50 is concave to define an inner ring 501, and a lower end of the connection sleeve 50 protrudes inward to define the third flange 53, and the third flange 53 abuts the annular groove 520 of the plug 60, so that the third flange 53 is configured to be embedded in the annular groove 520 of the plug 60 in the inner ring 501 of the connection sleeve 50, the plug 60 and the third flange 53 are configured to be connected to the inner side of the connection sleeve 50. A size parameter of the diameter of the connection sleeve 50 cooperates with the shaft sleeve inner holes (i.e., the inner rings 112) of the two first shaft sleeves 11 and the shaft sleeve inner hole 23 of the second shaft sleeve 21, the connection sleeve 50 passes through the shaft sleeve inner holes 112 and the shaft sleeve inner hole 23, so that the connection sleeve 50, the two first shaft sleeves 11, and the second shaft sleeve 21 can be secured together. The screw thread 702 of the adjusting base 70 cooperates with and is screwed to the plug 60 to rotate the adjusting base 70 to control an axis position of the adjusting base 70. The screw rod 32 cooperates with and is screwed to the screw sleeve 40 to limit the distance position that the damping positioning pull rod 01 axially slides and moves downward in the air cylinder 07 and the air chamber 009, so that the first blade 12 of the first hinge blade 10 is configured to be positioned at a preset positioning angle position. For example, when the hinge blades are disposed below a preset positioning angle position of 80 degrees, the first blade 12 of the first hinge blade 10 can generate a relatively weak positioning force.

The plug 60 comprises a plug through screw hole 701, and the screw thread 702 of the adjusting base 70 cooperates with and is screwed in the plug though screw hole 701, and hermetically abuts an inner side of the air chamber vent through hole 007, so that the adjusting base protruding valve 700 of the adjusting base 70 is configured to abut the air chamber vent through hole 007 disposed in the air chamber 009, the adjusting base 70 is configured to be adjusted by external force to rotate to cooperate with the plug 60, the air cylinder 07, the damping positioning pull rod 01, and the screw sleeve 40, the adjusting base protruding valve 700 of the adjusting base 70 is configured to limit the exhaust volume of the air chamber vent through hole 007, the adjusting base 70 is configured to be adjusted by the external force to rotate to cooperate with the plug 60 and to cooperate with the air cylinder 07, the air chamber 009, the damping positioning pull rod 01, and the screw sleeve 40, a gap size between the adjusting base protruding valve 700 and the air chamber vent through hole 007 is configured to be adjusted. A plug vent through hole 611 disposed on a circumferential periphery of the inner ring and the outer ring of the plug 60 is aligned with a second shaft sleeve vent through hole 6112 disposed on a circumferential periphery of the inner ring and the outer ring of the second shaft sleeve 21, and the plug vent through hole 6111, the second shaft sleeve vent through hole 6112, and the air chamber vent through hole 007 are in communication with each other.

When the first blade 12 is opened from a left side by the external force, the first blade 12 is configured to drive the transmission rod 42 and the screw rod 32 to rotate, so that the screw sleeve 40 and the damping positioning pull rod 01 are configured to slide downward relative to the screw rod 32. At the same time, the damping positioning pull rod 01 and the first sealing rubber ring 005 slide and move downward in the air chamber 009 disposed in the air cylinder 07, the first sealing rubber ring 005 generates a relatively great frictional damping positioning force in the air chamber 009, the first blade 12 is further configured to generate a relatively great self-positioning force. At the same time, the first blade 12 is opened to a hinge blade preset positioning angle from 1° to 180°, the adjusting base 70 is configured to be adjusted by external force to rotate to cooperate with the plug 60 and to cooperate with the air cylinder 07, the air chamber 009, the damping positioning pull rod 01, and the screw sleeve 40, the size of the gap between the adjusting base protruding valve 700 of the adjusting base 70 and the air chamber vent through hole 007 is configured to be adjusted , the hinge blades are positioned at any angle position between a 1° opening angle of the hinge blades and a 180° opening angle of the hinge blades, the adjusting base 70 is always configured to adjust a positioning force of the hinge blades, the hinge blades are configured to be positioned between the 1° opening angle of the hinge blades and the 180° opening angle of the hinge blades, so that the first blade 12 of the first hinge blade 10 disposed in between a 1° angle and a 180° positioning angle of a preset positioning angle of the hinge blades to enable the first blade 12 of the first hinge blade 10 to generate a self-positioning function.

### Embodiment 2

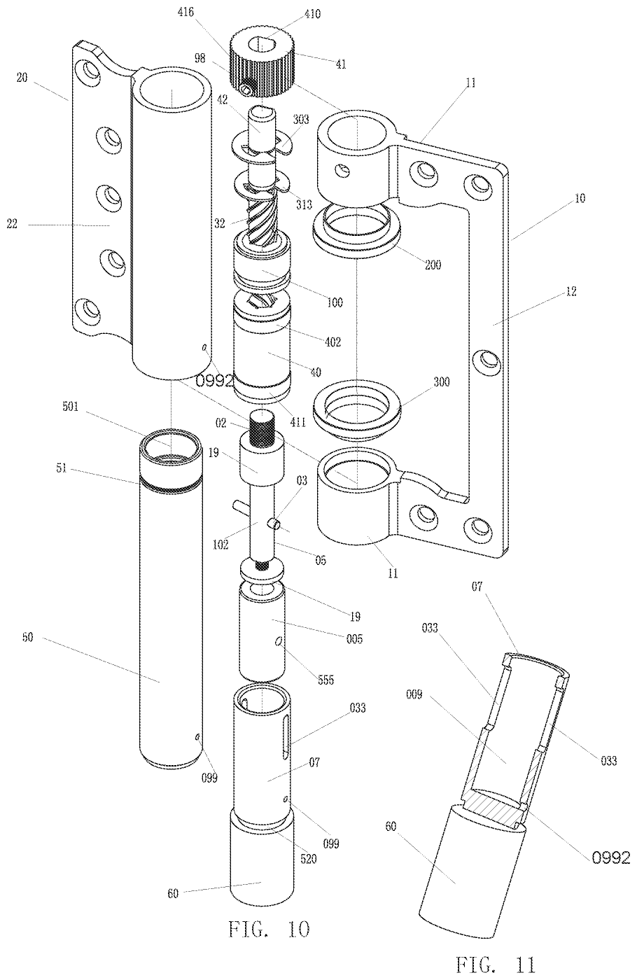

Embodiment 2 differs from Embodiment 1 in that: referring to FIGS. 10 and 11, the circumferential peripheries of the inner ring and the outer ring of the bottom of the air chamber 009 comprise the air chamber vent through hole 0992; diameter sizes and positions of the air chamber vent through hole 0992, a connection sleeve vent through hole 099 disposed on the circumferential peripheries of the inner ring and the outer ring of the connection sleeve 50, a second shaft sleeve vent through hole 0991 disposed on a circumferential periphery of inner and outer rings of the second shaft sleeve 21 are consistently aligned. Values of the diameter sizes of the air chamber vent through hole 0992, the connection sleeve vent though hole 099, and the second shaft sleeve vent through hole 0991 are smaller. Therefore, the first blade 12 is opened from the left side by the external force, the first blade 12 is configured to drive the transmission rod 42 and the screw rod 32 to rotate, the screw sleeve 40 and the damping positioning pull rod 01 are configured to slide axially relative to the screw rod 32. At the same time, when the damping positioning pull rod 01 and the first sealing rubber ring 005 slide and move in the air cylinder 07 and the air chamber 009, the damping positioning pull rod 01 and the first sealing rubber ring 005 are configured to generate greater frictional damping positioning force in the air cylinder 07 and the air chamber 009 to enable the first blade 12 to generate a stronger self-positioning force. The values of diameter sizes of the air chamber vent through hole 0992, the connection sleeve vent though hole 099, and the second shaft sleeve vent through hole 0991 are larger. Therefore, the first sealing rubber ring 005 disposed on the damping positioning pull rod 01 generates a weaker frictional damping positioning force in the air cylinder 07 and the air chamber 009, the first blade 12 of the first hinge blade 10 is configured to generate a weaker self-positioning force. The plug 60 of Embodiment 2 does not comprises the plug through screw hole 701 of the adjusting base 70 and the adjusting base 70. The high pressure extrusion compressed gas generated due to the damping positioning pull rod 01 and the first sealing rubber ring 005 sliding and moving in the air cylinder 07 and the air chamber 009 is exhausted through the air chamber vent through hole 0992 and the connection sleeve vent through hole 099, and the second shaft sleeve vent through hole 0991; the high pressure suction compressed gas generated due to the damping positioning pull rod 01 and the first sealing rubber ring 005 sliding and moving in the air cylinder 07 and the air chamber 009 is sucked through the second shaft sleeve vent through hole 0991, the connection sleeve vent through hole 099, and the air chamber vent through hole 0992. The air chamber vent through hole 0992, the connection sleeve vent through hole 099, and the second shaft sleeve vent through hole 0991 are in communication with each other and are in communication with the air source in high pressure.

### Embodiment 3

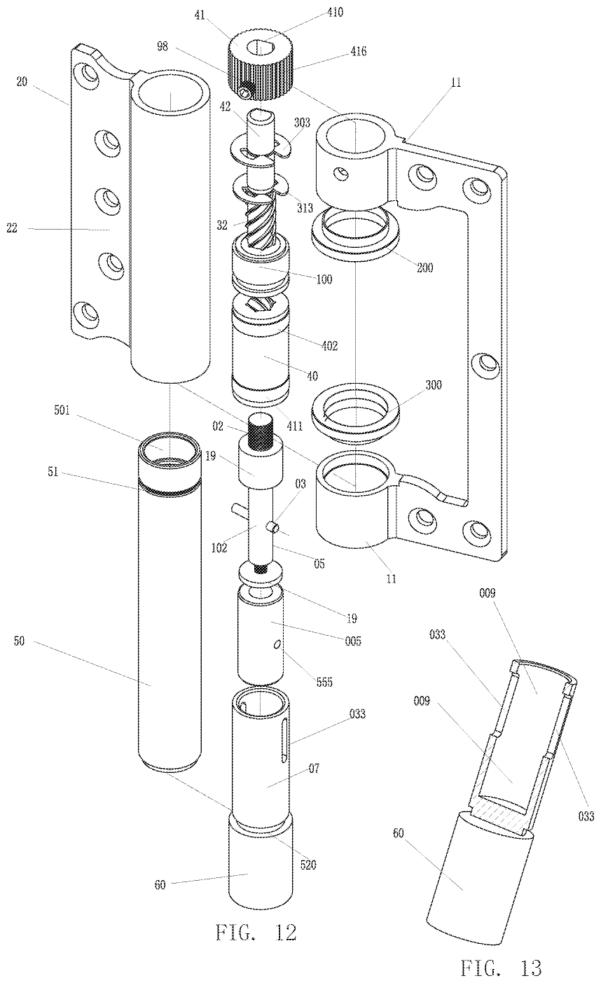

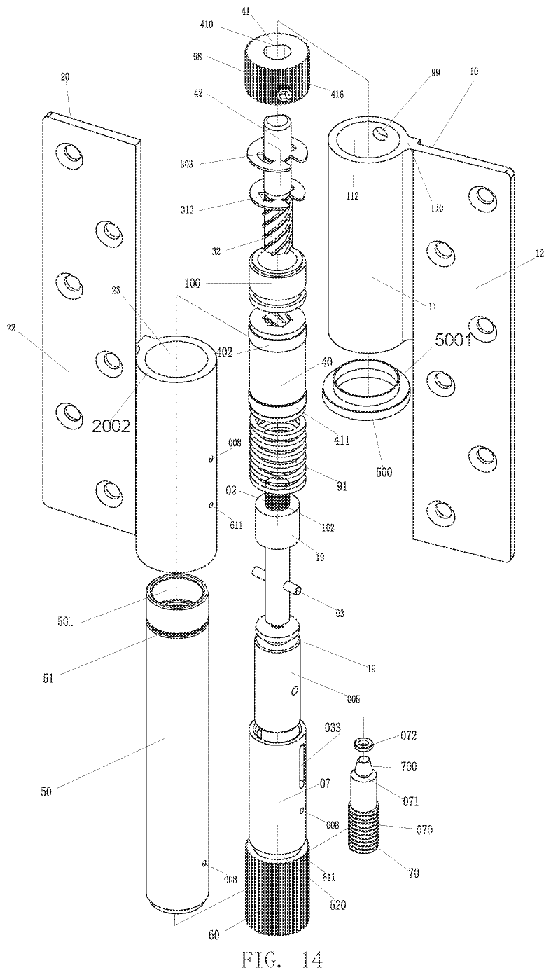

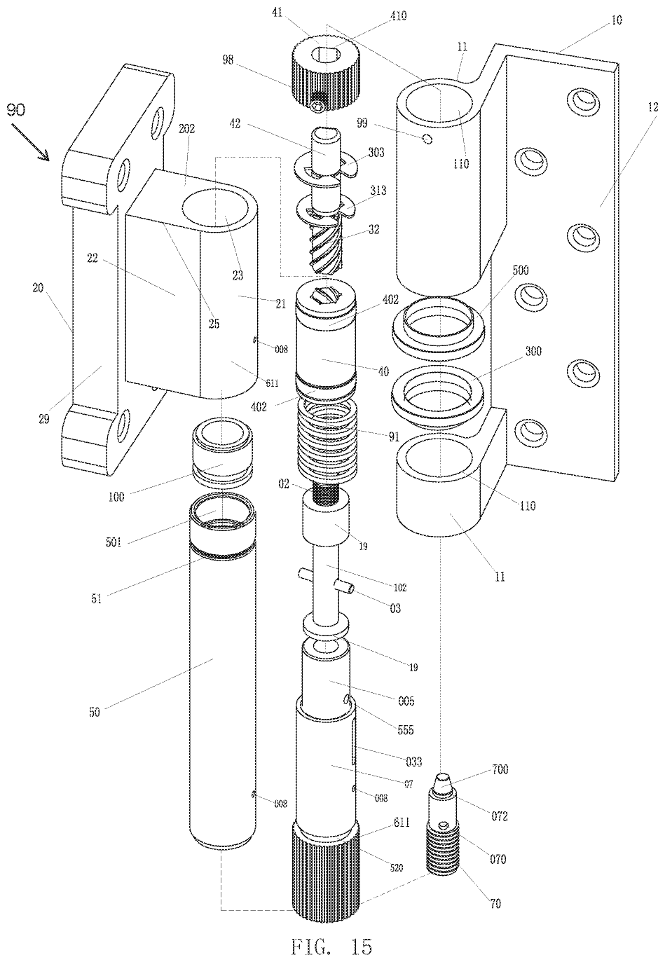

Embodiment differs from Embodiment 2 in that: referring to FIGS. 12 and 13, the circumferential peripheries of the inner ring and the outer ring of the air chamber 009 does not comprise an air chamber vent through hole 0992, and the circumferential peripheries of the inner ring and the outer ring of the air cylinder 07 does not comprises the positioning vent through hole 008. The circumferential periphery of the outer ring of the damping positioning pull rod 01 comprises the pull rod annular mounting groove 05, and after the inner hole 055 of the first sealing rubber ring 005 cooperates with and encompasses the inner side of the pull rod annular mounting groove 05 of the positioning pull rod connection rod 102, the screw rod 091 of the protruding ring 19 is screwed in the pull rod screw hole 81, so that the screw rod 091 of the protruding ring 19 is configured to be secured to the positioning pull rod connection rod 102 of the damping positioning pull rod 01. The first sealing rubber ring 005 further extends out of the pull rod annular mounting groove 05 and further extends out of the diameters of the protruding rings 19 disposed on the two ends of the damping positioning pull rod 01. Therefore, the first sealing rubber ring 005 is configured to strongly abut the wall of the inner side of the air cylinder 07, the damping positioning pull rod 01 is configured to hermetically and slidably abut the air cylinder 07, the screw sleeve 40 is configured to drive the damping positioning pull rod 01 to axially slide and move relative to the screw rod 32, the damping positioning pull rod 01 and the first sealing rubber ring 005 are configured to generate a strong frictional damping force and a strong frictional resistance force in the air cylinder 07, and the first blade 12 is configured to be positioned from the 1° opening angle of to the 180° opening angle.

### Embodiment 4

Embodiment 4 differs from Embodiment 3 in that: referring to FIG. 14, the second hinge blade 20 comprises the second shaft sleeve 21 and the second blade 22 secured to the outer side of the second shaft sleeve 21, the second shaft sleeve 21 is disposed on a lower half portion of the second blade 22; the first hinge blade 10 comprises a first shaft sleeve 11 and a first blade 12 disposed on an outer side of the first shaft sleeves 11. The first shaft sleeve 11 is disposed on an upper half portion of the first blade 12; the first shaft sleeve 11 cooperates with and is connected to the second shaft sleeve 21 and is aligned with the second shaft sleeve 21 up and down. Therefore, the first shaft sleeve 11 is configured to rotate relative to the axis of the second shaft sleeve 21 in the preset rotation angle of the first blade 12 of the first hinge blade 10.

The first shaft sleeve 11, the swivel ring 41, and the transmission rod 42 are connected together to enable the first shaft sleeve 11 and the swivel ring 41 to be configured to position and limit the axial direction and the distance position of the wheelbase that the screw sleeve 40 axially slides and moves relative to the screw rod 32 of the fixed rod 30. The inner side of the connection sleeve 50 comprises the second flange 52, and the second flange 52 is configured to abut the annular groove 520 of the plug 60 in the connection sleeve 50. Therefore, the second flange 52 is configured to be embedded in the annular groove 520 of the plug 60 in the connection sleeve 50, and the plug 60 and the second flange 52 are configured to be secured in the connection sleeve 50. A fifth bearing 500 is configured to rotatably encompass the connection sleeve 50. A bearing protruding ring 5001 of one end of the fifth bearing 500 rotatably is encompassed in the inner ring 112 and the other end surface of the circumferential periphery of the end surfaces 100 of the circumferential periphery of the first shaft sleeve 11 is configured to abut an end surface 2002 of a circumferential periphery of inner and outer rings of the second shaft sleeve 21. The first shaft sleeve 11 and the second shaft sleeve 21 are disposed side to side to enable the first blade 12 to be configured to rotate relative to the second shaft sleeve 21. The connection sleeve 50 cooperates with and is encompassed in the shaft sleeve inner hole 23 of the second shaft sleeve 21 to enable the connection sleeve 50 to be configured to be secured in the shaft sleeve inner hole 23 of the second shaft sleeve 21.

The fixed rod 30, the screw sleeve 40, the damping positioning pull rod 01, the air cylinder 07, the air chamber 009, the first bearing 100, and the adjusting base 70 are disposed between the fixed rod 30 and the plug 60 of the connection sleeve 50 of the two hinge blades.

The first sealing rubber ring 005 encompasses the inner side of the annular mounting groove 05, and the first sealing rubber ring 005 further extends out of the annular mounting groove 05 to enable the damping positioning pull rod 01 to be configured to hermetically and slidably abut the inner sides of the air cylinder 07 and the air chamber 009. Therefore, the damping positioning pull rod 01 and the screw sleeve 40 is configured to axially slide and move relative to the screw rod 32 of the fixed rod 30, the damping positioning pull rod 01 hermetically disposed in the air cylinder 07 and air chamber 009 is configured to generate strong frictional damping force and frictional resistance force in the cylinder 07 and air chamber 009. When the damping positioning pull rod 01 hermetically disposed in the air cylinder 07 and air chamber 009 axially slides and moves downward in the air cylinder 07 and air chamber 009 and slides over the air cylinder vent through hole 008, at this time, the damping positioning pull rod 01 hermetically disposed in the air cylinder 07 and the air chamber 009 is disposed in the air chamber 009 of the air cylinder 07. At this time, the damping positioning pull rod 01 and the first sealing rubber ring 005 disposed on the damping positioning pull rod 01 is disposed in the air chamber 009 of the air cylinder 07 to generate large frictional damping positioning force. Therefore, the first blade 12 of the first hinge blade 10 generates greater positioning force. At the same time, the adjusting base 70 is adjusted to rotate by the external force to cooperate with the plug 60 and to cooperate with the air cylinder 07, the air chamber 009, the damping positioning pull rod 01, and the screw sleeve 40. Therefore, the size of the gap disposed between the adjusting base protruding valve 700 and the air chamber vent through hole 007 is configured to be adjusted, and the value of the positioning force of the hinge blades at any positioning angle is configured to be adjusted. When the hinge blades are not more than the preset positioning angle position of 90° or 80°, a stored energy of a spring 91 is configured to be released at the same time. Therefore, one end of the spring 91 is configured to strongly abut a circumferential end surface of the screw sleeve 40, and the other end of the spring 91 is configured to strongly abut a front annular end surface of the air cylinder 07, convex screw thread of the screw sleeve 40 is configured to slide and move upward relative to an axial direction of concave screw thread of the screw rod 32. At the same time, the first sealing rubber ring 005 disposed on the damping positioning pull rod 01 plays frictional damping function in the air cylinder 07. At the same time, the third sealing rubber ring 411 disposed on the screw sleeve 40 and the second sealing rubber ring 402 disposed on the screw sleeve further plays frictional damping function in the connection sleeve 50. Therefore, the first blade 12 can achieve a damping automatic close function. The high pressure extrusion compressed gas generated due to the damping positioning pull rod 01 and the first sealing rubber ring 005 sliding and moving downward in the air cylinder 07 and the air chamber 009 is discharged through the air chamber vent through hole 007, the plug vent through hole 6111 of the plug 60, the connection sleeve vent through hole 611, and the second shaft sleeve vent through hole 6112; and the high pressure suction compressed air generated due to the damping positioning pull rod 01 and the first sealing rubber ring 005 sliding and moving upward in the air cylinder 07 and the air chamber 009 is sucked from the second shaft sleeve vent through hole 6112, the connection sleeve vent through hole 611, the plug vent through hole 6111, and the air chamber vent through hole 007 in high pressure.

When the two hinge blades rotate relative to each other, the screw sleeve 40 and the screw rod 32 disposed in the two shaft sleeves are configured to rotate relatively, so that the screw sleeve 40 and the damping positioning pull rod 01 are configured to axially slide and move relative to the screw rod 32. The first blade 12 is opened from the left side by the external force. Therefore, the first blade 12 is configured to drive the transmission rod 42 and the screw rod 32 to rotate, the axial direction and the distance position of the wheelbase that the screw sleeve 40 and the damping positioning pull rod 01 axially slide and move relative to the screw rod 32 is preset and restricted due to the screw threads of the screw rod 32 and the screw sleeve 40, and the screw sleeve 40 and the damping positioning pull rod 01 are configured to axially slide downward relative to the screw rod 32 within the preset rotation angle of the hinge blades. When the damping positioning pull rod 01 slides over the positioning vent through hole 008 of the air cylinder 07, at this time, the damping positioning pull rod 01 is disposed in the air chamber 009 disposed in the air cylinder 07. At the same time, the damping positioning pull rod 01 generates a stronger frictional damping positioning force in the air chamber 009 disposed in the air cylinder 07 to enable the first blade 12 to generate a stronger positioning force. At the same time, when the first blade 12 is opened to the preset positioning angle position the hinge blades within 80° to 180°, at the same time, the adjusting base 70 is configured to adjust the value of the positioning force of the first blade 12 within the preset positioning angle position; when the first blade 12 needs to be closed and is closed to 80° position by the external force, that is, not more than the preset positioning angle position of the first blade 12, and when the first blade 12 is closed by the external force, the first blade 12 is configured to drive the swivel ring 41 and the transmission rod 42 disposed in the first shaft sleeve 11 and the screw rod 32 disposed in the first shaft sleeve 11 to rotate, so as to drive the screw sleeve 40 and the damping positioning pull rod 01 to slide and move upward and to slide over the positioning vent through hole 008 of the air cylinder 07 , that is, no more than a starting point in the preset positioning angle position of the first blade 12, gas will enter into the air cylinder 07 from the positioning vent through hole 008 of the second shaft sleeve 21 and the positioning vent through hole 008 of the connection sleeve 50. Therefore, the damping positioning pull rod 01 will lose all atmospheric pressure in the air cylinder 07, and at the same time, the damping positioning pull rod 01 will lose more positioning force in the air cylinder 07, and the first sealing rubber ring 005 and the second sealing rubber ring 006 disposed on the damping positioning pull rod 01 still have a slight frictional damping function in the air cylinder 07. At the same time, the third sealing rubber ring 411 disposed on the screw sleeve 40 and the second sealing rubber ring 402 disposed on the screw sleeve 40 also have slight frictional damping function in the connection sleeve 50. At the same time, when the external force driving the first blade 12 of the first hinge blade 10 is released, an elastic force the stored energy of the spring 91 is configured to be released at the same time, so that the first blade 12 can achieve a damping automatic close function.

The left and right sides of the circumferential periphery of the outer ring of the air cylinder 07 are aligned with each other to define the sliding rod through holes 033, and the sliding rod through holes 033 are aligned with the positioning pull rod through hole 08 disposed on the damping positioning pull rod 01. Therefore, the sliding rod 03 cooperates with and passes through the sliding rod through holes 033 of the air cylinder 07 and the positioning pull rod through hole 08, the sliding rod 03 is configured to be encompassed in the damping positioning pull rod 01 and the sliding rod through holes 033 disposed on the left and right sides of the circumferential periphery of the outer ring of the air cylinder 07. The positioning vent through hole 008 of the air cylinder 07, the positioning vent through hole 008 of the connection sleeve 50, and the positioning vent through hole 008 of the second shaft sleeve 21 are consistently aligned.

### Embodiment 5

The hinge structure, for example, can be disposed in shaft sleeves of vehicle door hinge blades, vehicle door folded hinge blades, and carriage door hinge blades, and can be disposed in the vehicle door defining any peculiar shape and the carriage door defining any peculiar shape, etc. Therefore, the vehicle door defining any peculiar shape and the carriage door defining any peculiar shape, etc. defines a functional structure that is configured to adjust a value of a positioning force of vehicle door hinge blades at any angle and is configured to be positioned and to be automatically closed at any angle. Embodiment 5 differs from Embodiment 4 in that: referring to FIG. 15, the first hinge blade 10 is disposed with the first blade 12 and two first shaft sleeves 11 secured to the first blade 12 at intervals, and the first blade 12 of the first hinge blade 10 defines a folded blade shape (the first blade 12 of the first hinge blade 10 may not define the folded blade shape); A fixed base 90 comprises a fixed plate 29 and a vertical protruding base 25 fixed on the fixed plate 29, an end surface of the vertical protruding base 25 is concave to define the second shaft sleeve 21. The fixed base 90 is configured to define the second hinge blade 20, and the fixed base 90 is also configured to define the fixed plate 29. A wheelbase of the second shaft sleeve 21 cooperates with a gap distance disposed between the two first shaft sleeves 11, and the second shaft sleeve 21 cooperates with and is disposed between the two first shaft sleeves 11. Therefore, the two first shaft sleeves 11 are configured to rotate relative to the axis of the second shaft sleeve 21 within the preset positioning angle position of the first blade 12; the second blade 22 is secured to the fixed base 90, and the fixed screw 98 passes through a screw hole of the fixed base 90 of the hinge blades and passes through a through hole of a vehicle door frame to enable the fixed base 90 of the hinge blades to be secured to the vehicle door frame. Therefore, vehicle door blades are configured to adjust the value of the positioning force of the hinge blades and to be automatically closed. When the two hinge blades rotate relative to each other, the screw sleeve 40 and the screw rod 32 are configured to rotate relative to each other in the two shaft sleeves, so that the screw sleeve 40 and the damping positioning pull rod 01 are configured to axially slide and move relative to the screw rod 32 within the preset positioning angle.

The first blade 12 is opened by the external force to enable the first blade 12 to drive the transmission rod 42 and the screw rod 32 to rotate. A straight-oblique pitch of convex teeth of three straight-oblique pitch of the screw rod 32 and a number structure disposed the convex teeth of straight-oblique pitch cooperates with straight-oblique pitch of convex teeth of three straight-oblique pitch of the screw sleeve 40 and a number structure disposed the convex teeth of straight-oblique pitch. Therefore, the axial direction and the distance position of the wheelbase that the screw sleeve 40 and the damping positioning pull rod 01 axially slides and moves relative to the screw rod 32 is preset and restricted.

### Embodiment 6

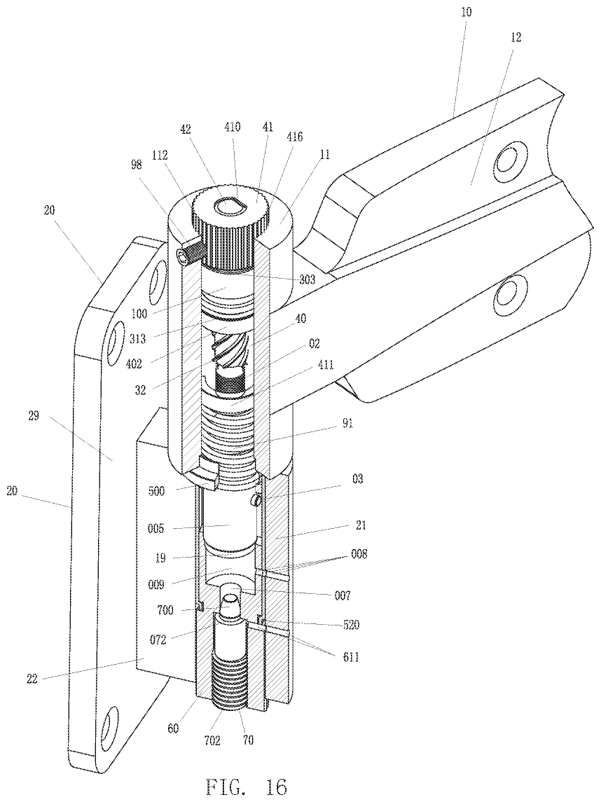

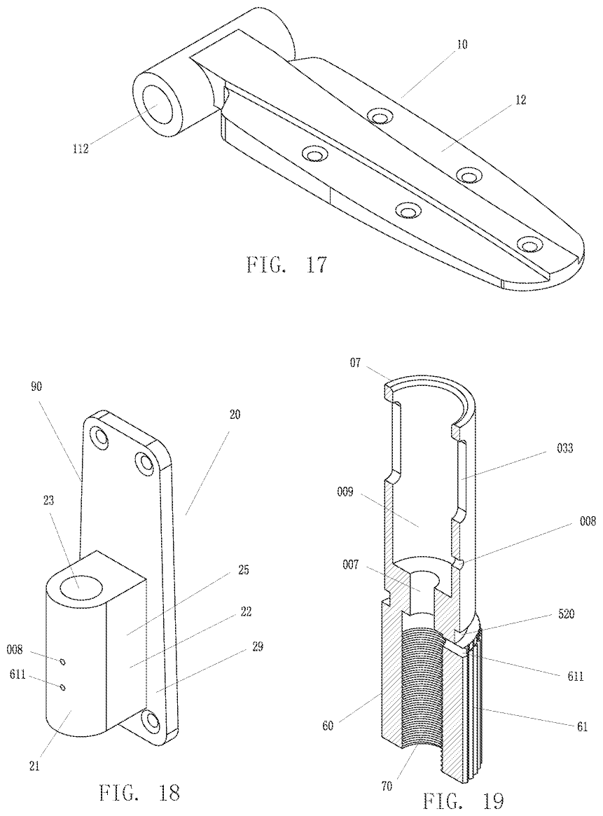

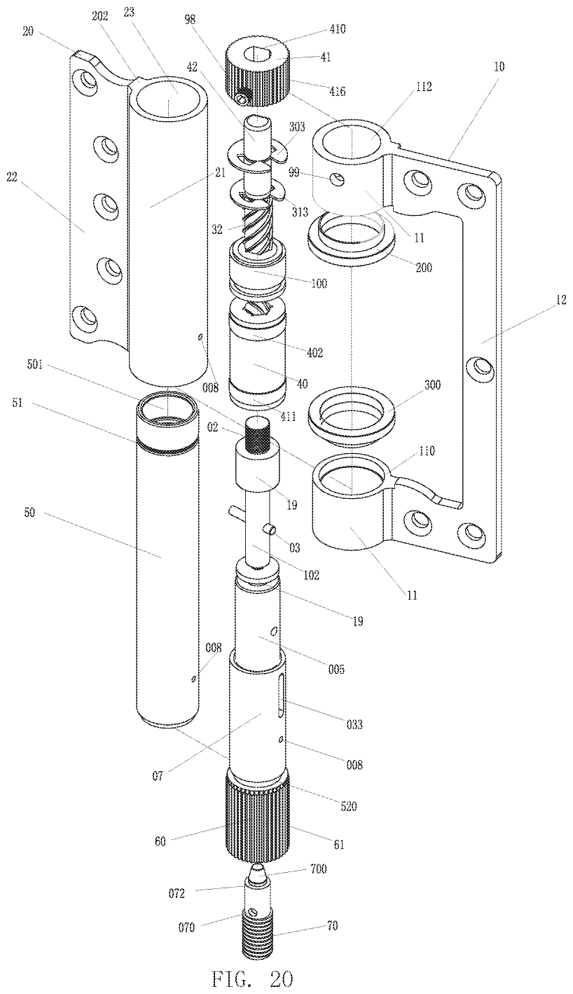

The hinge structure, for example, is suitable to be disposed in shaft sleeves of hinges of high hermetic flat doors and convex doors to enable the hinges of the high hermetic flat door and the convex doors to adjust the positioning force in a whole process and the positioning force in a second half of the hinge blades are configured to be disposed on any of freezer door, refrigerator door, cold storage door, oven door, oven test equipment door, test box door, simulated environment test equipment door, mechanical equipment door, drying equipment door, soundproof door, special door, freshness-keeping warehouse door, tea-keeping warehouse door, civil engineering door, and a door page of any ship door, etc. Referring to FIGS. 16-19, Embodiment 6 differs from Embodiment 5 in that the first hinge blade 10 comprises a first shaft sleeve 11 and a first blade 12. The first shaft sleeve 11 is disposed on an upper half portion of the first blade 12, while the first shaft sleeve 11 cooperates with and is connected to the second shaft sleeve 21 and is aligned with the second shaft sleeve 21 up and down, so that the first shaft sleeve 11 is configured to rotate relative to the axis of the second shaft sleeve 21 within the preset positioning angle position of the first blade 12. The connection sleeve 50 is connected to the inner sides of the first shaft sleeve 11 and the second shaft sleeve 21; the fifth bearing 500 is rotatably connected between the first shaft sleeve 11 and the second shaft sleeve 21 of the vertical protruding base 25, the fifth bearing 500 further rotatably encompasses the outer side of the connection sleeve 50, so that the first hinge blade 10 rotate more smoothly relative to the axis of the fixed base 90. The first shaft sleeve 11 and the second shaft sleeve 21 of the vertical protruding base 25 are disposed side to side. Therefore, the first blade 12 of the first hinge blade 10 is configured to rotate relative to the second shaft sleeve 21 of the vertical protruding base 25, and the hinge is configured to define a high hermetic hinge structure of the convex doors or the flat doors.

The adjusting base protruding valve 700 is disposed on the front annular end surface of the adjusting base 70. The diameter of the air chamber vent through hole 007 cooperates with the diameter and the taper degree of the protruding valve of the adjusting base 70. Therefore, the protruding valve of the adjusting base 70 is configured to cooperate with the adjusting base 70, the adjusting base 70 is configured to be adjusted to rotate to correspond with the plug 60 and to cooperate with the air cylinder 07, the air chamber 009, the damping positioning pull rod 01, and the screw sleeve 40, and the adjusting base protruding valve 700 of the adjusting base 70 is configured to limit the discharge volume and the intake volume of the air chamber vent through hole 007.

After the first sealing rubber ring 005 cooperates and encompasses the inner side of the pull rod annular mounting groove 05 of the positioning pull rod connection rod 102, the screw rod 091 of the second protruding ring 19 is screwed in the pull rod screw hole 81. The screw rod 091 of the second protruding ring 19 is secured to the positioning pull rod connection rod 102 of the damping positioning pull rod 01, and the first sealing rubber ring 005 further extends out of the pull rod annular mounting groove 05 and also extends out of the diameters of the protruding rings 19 disposed on two ends of the damping positioning pull rod 01. Therefore, the first blade 12 generates the positioning function during the opening process, the adjusting base 70 is configured to be adjusted to rotate to correspond with the plug 60 and to cooperate with the air cylinder 07, the air chamber 009, the damping positioning pull rod 01, and the screw sleeve 40 by the external force, the size of the gap disposed between the adjusting base protruding valve 700 and the air chamber vent through hole 007 is configured to be adjusted.

The second end of the damping positioning pull rod 01 comprises the pull rod screw hole 81, the first sealing rubber ring 005 cooperates and encompasses the pull rod annular mounting groove 05 of the positioning pull rod connection rod 102. The screw rod 091 is disposed on a front edge of the front surface of the end of the second protruding ring 19, and the screw rod 091 cooperates with and is screwed in the pull rod screw hole 81 of the screw rod 32. Therefore, the screw rod 091 is secured to the positioning pull rod connection rod 102, the damping positioning pull rod 01 defines the pull rod annular mounting groove 05, the first sealing rubber ring 005 is secured, and a displacement and a disassembly of the first sealing rubber ring 005 is restricted.

The first end of the damping positioning pull rod 01 is disposed with a connection screw rod 02, and the connecting screw rod 02 of the damping positioning pull rod 01 is screwed in the screw sleeve screw hole 406 of the screw sleeve 40 to enable the damping positioning pull rod 01 to be secured to the screw sleeve 40. The sliding rod 03 is configured to be secured to the positioning pull rod through hole 08 of the damping positioning pull rod 01, while the sliding rod 03 abuts the sliding rod through holes 033 disposed on the left and right sides of the circumferential periphery of the outer ring of the air cylinder 07, the sliding rod through holes 033 disposed on the left and right sides of the circumferential periphery of the outer ring of the air cylinder 07 are aligned with each other. Therefore, the sliding rod 03 is configured to position and restrict the axial direction and the distance position of the wheelbase that the screw sleeve 40 and the damping positioning pull rod 01 slides and moves up and down to be not changed. The damping positioning pull rod 01 and the first sealing rubber ring 005 are configured to axially slide and move along in the air cylinder 07 and the air chamber 009 to generate strong damping positioning force due to strong friction. The first blade 12 generates stronger positioning force within the preset positioning angle position, when the hinge blades are positioned to be not more than the preset positioning angle position of 90° or 80°, the elastic force of the stored energy of the spring 91 is configured to be released to enable the first blade 12 to achieve an damping automatic close.

### Embodiment 7

Embodiment 7 differs from Embodiment 1 in that: please refer to FIG. 20, an internal structure of the adjusting base 70 comprises an adjusting base discharge-intake hole 070, and the adjusting base 70 is disposed with an adjusting base protruding valve 700, the adjusting base protruding valve 700 is configured to hermetically and slidably abut the air chamber vent through hole 007 to enable the adjusting base protruding valve 700 to cooperate with the adjusting base 70, so that the adjusting base 70 is configured to be adjusted to rotate to adjust the size of the gap disposed between the adjusting base protruding valve 700 and the air chamber vent through hole 007 by the external force. The circumference of the inner ring and the outer ring of the air cylinder 07 comprise the positioning vent through hole 008 (i.e., positioning through hole) of the air cylinder 07. Before the damping positioning pull rod 01 slides through the positioning vent through hole 008, gas in the air chamber 009 is discharged through the positioning vent through hole 008. When the damping positioning pull rod 01 slides over the positioning vent through hole 008 of the air cylinder 07 (i.e., the positioning vent through hole 008 is sealed by the damping positioning pull rod 01) and then continues to downwardly slide toward and close to the air chamber vent through hole 007, the damping positioning pull rod 01 in the air cylinder 07 and the air chamber 009 will highly compress and squeeze the gas source in the air chamber 009, so that the gas source in the air chamber 009 will be discharged through the gap between the air chamber vent through hole 007 and the adjusting base vent through hole 070. Before the damping positioning pull rod 01 upwardly or downwardly slides toward and close to the positioning vent through hole 008 in the air chamber 009, at the same time, the adjusting base 70 is adjusted to rotate by the external force, the size of the gap disposed between the adjusting base protruding valve 700 and the air chamber vent through hole 007 is configured to be adjusted. In case that the gap disposed between the adjusting base protruding valve 700 of the adjusting base 70 and the air chamber vent through hole 007 is adjusted to be larger, the pressure of the air source, the value of the compression ratio pressure of the high pressure suction-expiration air source, and the pressure intensity in the air chamber 009 generated by the damping positioning pull rod 01 hermetically disposed in the air chamber 009 will be smaller. At the same time, upward resistance force and pulling force of the damping positioning pull rod 01 hermetically disposed in the air chamber 009 will be smaller in the air chamber 007, and the positioning force of the first blade 12 of the first hinge blade 10 disposed on the preset positioning angle position will be smaller. In case that the gap disposed between the adjusting base protruding valve 700 and the air chamber vent through hole 007 is adjusted to be smaller, the pressure value of the air source, the compression ratio of high pressure suction-expiration air source, and the pressure intensity value of the air source in the air chamber 007 generated by the damping positioning pull rod 01 hermetically disposed in the air chamber 007, and the pressure value of the air source, and the compression ratio of high pressure suction-expiration air source, and the pressure intensity in the air chamber 007 generated by the damping positioning pull rod 01 and the first sealing rubber ring 005 of the damping positioning pull rod 01 will be larger. At the same time, upward and downward resistance force and pulling force of the damping positioning pull rod 01 in the air chamber 007 hermetically disposed in the air chamber 007 is larger, and the positioning force of the first blade 12 of the first hinge blade 10 positioned at the preset positioning angle position is larger. When the damping positioning pull rod 01 slides upward in the air chamber 009 and slides over the positioning vent through hole 008, at the same time, the first sealing rubber ring 005 disposed on the annular mounting groove 05 of the damping positioning pull rod 01 further extends out of the annular mounting groove 05. Therefore, the damping positioning pull rod 01 is configured to hermetically and slidably abut the air cylinder 07 and the air chamber 009, the damping positioning pull rod 01 is configured to generate strong frictional damping force and strong frictional resistance force in the air cylinder 07, the damping positioning pull rod 01 and the screw sleeve 40 axially slide and move relative to the screw rod 32 of the fixed rod 30, and the first blade 12 is configured to be positioned in the preset positioning angle position. For example, when the hinge blades are positioned at an angle being not more than the preset positioning angle position of 80°, the first blade 12 is configured to generate a weak positioning force.

### Embodiment 8

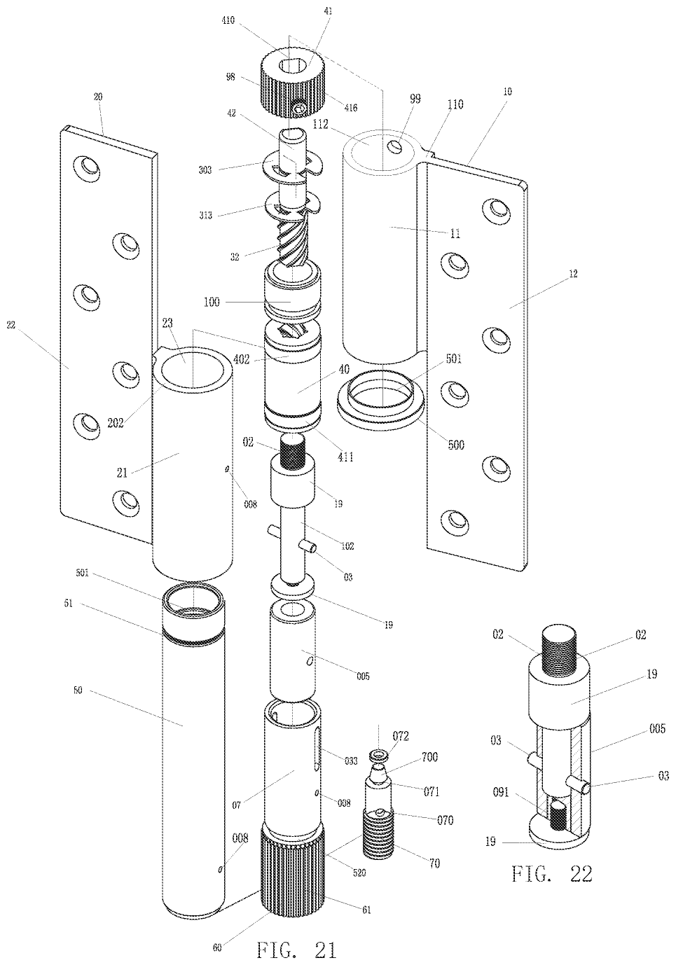

Embodiment 8 differs from Embodiment 7 in that: referring to FIGS. 21 and 22, the second hinge blade 20 comprises the second shaft sleeve 21 and the second blade 22 secured to the outer side of the second shaft sleeve 21, the second shaft sleeve 21 is disposed on a lower half portion of the second blade 22; the first hinge blade 10 comprises a first shaft sleeve 11 and a first blade 12 secured to the outer side of the first shaft sleeve 11. The first shaft sleeve 11 is disposed on an upper half portion of the first blade 12. The first shaft sleeve 11 is disposed on the second shaft sleeve 21 and is aligned with the second shaft sleeve 21 up and down.

### Embodiment 9

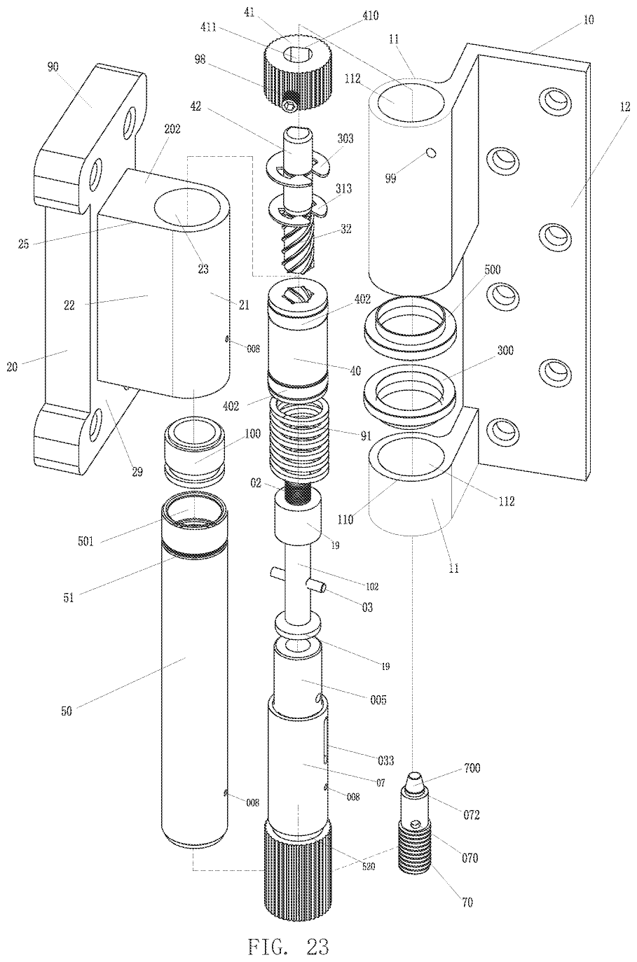

Embodiment 9 differs from Embodiment 7 in that: referring to FIG. 23, the first hinge blade 10 comprises a first blade 12 and two first shaft sleeves 11, and the first blade 12 of the first hinge blade 10 defines a folded blade shape (i.e., the first blade 12 of the first hinge blade 10 may not be disposed in the folded blade shape); a fixed base 90 comprises a fixed plate 29 and a vertical protruding base 25 secured to the fixed plate 29. An end surface of the vertical protruding base 25 is concave to define the second shaft sleeve 21. The fixed base 90 is configured to define the second hinge blade 20, and the fixed base 90 is also configured to define the fixed plate 29. A wheelbase of the second shaft sleeve 21 cooperates with a distance of the gap disposed between the two first shaft sleeves 11, and the second shaft sleeve 21 cooperates with and is disposed between the two first shaft sleeves 11. Therefore, the first shaft sleeve 11 is configured to rotate relative to the axis of the second shaft sleeve 21 within the preset positioning angle position of the first blade 12 of the first hinge blade 10; the second blade 22 of the second shaft sleeve 21 of the second hinge blade 20 is secured to the fixed base 90 of the hinge blades, the fixed screw 98 passes through and is secured to a screw through hole of the fixed base 90 of the hinge blades and a screw through hole of a vehicle door frame. Therefore, the fixed base 90 of the hinge blades are secured to the vehicle door frame, and vehicle door blades are configured to adjust the value of the positioning force of the hinge blades within the preset positioning angle position and to be automatically closed. When the two hinge blades rotate relative to each other, the screw sleeve 40 and the screw rod 32 disposed in the two shaft sleeves are configure to rotate relative to each other, so that the screw sleeve 40 and the damping positioning pull rod 01 are configure to axially slide and move downward and upward relative to the screw rod 32 within the preset positioning angle position of the hinge blades.

The aforementioned embodiments are merely some embodiments of the present disclosure, and the scope of the disclosure is not limited thereto. Thus, it is intended that the present disclosure cover any modifications and variations of the presently presented embodiments provided they are made without departing from the appended claims and the specification of the present disclosure.

What is claimed is:

1. A hinge blade structure, comprising:
two hinge blades,
a connection sleeve,
a fixed rod,
a screw sleeve,
a plug,
a damping positioning pull rod, and
an air cylinder, wherein:
each hinge blade of the two hinge blades comprises a shaft sleeve and a blade secured to an outer side of the shaft sleeve,
the shaft sleeves of the two hinge blades at least partially encompass the connection sleeve to enable the two hinge blades to be configured to rotate relative to each other,
the fixed rod and the plug are connected to an inner side of the connection sleeve,
the fixed rod is separated from the plug,
the fixed rod and the plug are respectively and relatively secured to the shaft sleeve of one hinge blade of the two hinge blades,
the screw sleeve is disposed in the connection sleeve and disposed between the fixed rod and the plug,
the fixed rod comprises a screw rod,
the screw rod is screwed to the screw sleeve,
the damping positioning pull rod and the air cylinder are both disposed in the connection sleeve and disposed between the fixed rod and the plug,
the air cylinder is relatively secured to the plug,
the damping positioning pull rod is relatively secured to the screw sleeve,
the damping positioning pull rod is slidably connected to an inner side of the air cylinder along a length direction of the connection sleeve,
the damping positioning pull rod and the air cylinder cooperate to define an air chamber,
the air cylinder comprises an air chamber vent through hole and an air inlet, and
a resistance force generated between the air chamber and the damping positioning pull rod achieves positioning.

2. The hinge blade structure according to claim 1, comprising:
an adjusting base, wherein:
the adjusting base is movably connected to the plug, and
the adjusting base moves relative to the air cylinder to adjust a size of a gap disposed between the adjusting base and the air chamber vent through hole to adjust the resistance force between the air chamber and the damping positioning pull rod and to adjust a positioning force of the two hinge blades.

3. The hinge blade structure according to claim 1, comprising:
a swivel ring, wherein:
the swivel ring is disposed in the connection sleeve,
the fixed rod is relatively secured to the swivel ring, and
the swivel ring is secured in the shaft sleeve of one hinge blade of the two hinge blades.

4. The hinge blade structure according to claim 1, comprising:
a first bearing, wherein the first bearing is connected between the fixed rod and the connection sleeve.

5. The hinge blade structure of claim 1, wherein:
a sealing rubber ring encompasses the damping positioning pull rod, and
the sealing rubber ring is slidably connected to and abuts an inner side of a wall of the air cylinder.

6. The hinge blade structure according to claim 2, wherein:
the adjusting base is disposed with an adjusting base protruding valve, and
the adjusting base protruding valve and the air chamber vent through hole cooperate to adjust the size of the gap due to a movement of the adjusting base.

7. The hinge blade structure according to claim 1, comprising:
a positioning vent through hole penetrating the air cylinder, the connection sleeve, and an inner ring and an outer ring of the shaft sleeve, wherein:
the damping positioning pull rod cooperates with the positioning vent through hole of the air cylinder, and
a preset angle of positioning force is controlled due to an opening position of the positioning vent through hole of the air cylinder.

8. The hinge blade structure according to claim 4, wherein:
the shaft sleeves of the two hinge blades respectively define a first shaft sleeve and a second shaft sleeve,
the connection sleeve comprises a first flange and a third flange,
the first flange comprises an annular groove configured to be embedded with the first bearing at an inner ring and an outer ring of a circumferential periphery of the connection sleeve,
the third flange comprises an annular groove configured to be embedded with the plug at the inner ring and the outer ring of the circumferential periphery of the connection sleeve,
a portion of the plug protruding out of the connection sleeve cooperates with and passes through an inner hole of the first shaft sleeve to enable the plug to be secured to the first shaft sleeve,
the screw sleeve is encompassed in the connection sleeve and is configured to slide upward and downward, and
the fixed rod is configured to be rotatably and not slidably encompassed in the connection sleeve.

9. The hinge blade structure according to claim 5, wherein:
a circumferential periphery of an outer ring the damping positioning pull rod comprises a pull rod annular mounting groove,
two ends of the damping positioning pull rod are provided with protruding rings,
a sealing rubber ring inner hole of the sealing rubber ring cooperates with and encompasses the pull rod annular mounting groove of the damping positioning pull rod,
a diameter of the sealing rubber ring extends out of the pull rod annular mounting groove and also extends out of diameters of the protruding rings of the two ends of the damping positioning pull rod,
a size value of the diameter of the sealing rubber ring is larger than an inner diameter of an inner ring of the air cylinder,
the sealing rubber ring disposed on the damping positioning pull rod is configured to strongly abut a wall of the inner ring of the air cylinder, and
the damping positioning pull rod is configured to be hermetically and slidably connected to and abut the inner side of the air cylinder.

10. The hinge blade structure according to claim 6, wherein:
the adjusting base protruding valve defines a tapered structure, and
the size of the gap is adjusted due to a sliding direction of the adjusting base and the air cylinder along the screw sleeve.

11. The hinge blade structure according to claim 1, comprising:
a spring, wherein the spring abuts and is disposed between the screw sleeve and the air cylinder.

12. A hinge blade structure, comprising:
two hinge blades,
a connection sleeve,
a fixed rod,
a screw sleeve,
a plug,
a damping positioning pull rod,
an air cylinder, and
an adjusting base, wherein:
each hinge blade of the two hinge blades comprises a shaft sleeve and a blade secured to an outer side of the shaft sleeve,
the shaft sleeves of the two hinge blades at least partially encompass the connection sleeve to enable the two hinge blades to rotate relative to each other,
the fixed rod and the plug are connected to an inner side of the connection sleeve,
the fixed rod is separated from the plug,
the fixed rod and the plug are respectively and relatively secured to the shaft sleeve of one hinge blade of the two hinge blades,
the screw sleeve is disposed in the connection sleeve and disposed between the fixed rod and the plug,
the fixed rod comprises a screw rod,
the screw rod is screwed to the screw sleeve,
the damping positioning pull rod and the air cylinder are both disposed in the connection sleeve and disposed between the fixed rod and the plug,
the air cylinder is relatively secured to the plug,
the damping positioning pull rod is relatively secured to the screw sleeve,
the damping positioning pull rod is slidably connected to an inner side of the air cylinder along a length direction of the connection sleeve,
the damping positioning pull rod and the air cylinder cooperate to define an air chamber,
the air cylinder comprises an air chamber vent through hole,
the adjusting base is movably connected to the plug, and
a size of a gap disposed between the adjusting base and the air chamber vent through hole, a resistance force between the air chamber and the damping positioning pull rod, and positioning force of the hinge blades are configured to be adjusted due to a relative movement between the adjusting base and the air chamber.

13. The hinge blade structure according to claim 12, comprising:
a swivel ring, wherein:
the swivel ring is disposed in the connection sleeve,
the fixed rod is relatively secured to the swivel ring, and
the swivel ring is secured in the shaft sleeve of one hinge blade of the two hinge blades.

14. The hinge blade structure according to claim 12, comprising:
a first bearing, wherein the first bearing is connected between the fixed rod and the connection sleeve.

15. The hinge blade structure according to claim 12, wherein:
a sealing rubber ring encompasses the damping positioning pull rod, and
the sealing rubber ring is slidably connected to and abuts an inner side of a wall of the air cylinder.

16. The hinge blade structure according to claim 12, wherein:
the adjusting base is disposed with an adjusting base protruding valve, and
the adjusting base protruding valve and the air chamber vent through hole cooperate to adjust the size of the gap due to a movement of the adjusting base.

17. The hinge blade structure according to claim 12, comprising:
a positioning vent through hole penetrating the air cylinder, the connection sleeve, and an inner ring and an outer ring of the shaft sleeve, wherein:
the damping positioning pull rod cooperates with the positioning vent through hole of the air cylinder, and
a preset angle of positioning force is controlled due to an opening position of the positioning vent through hole of the air cylinder.

18. The hinge blade structure according to claim 14, wherein:
the shaft sleeves of the two hinge blades respectively define a first shaft sleeve and a second shaft sleeve,
the connection sleeve comprises a first flange and a third flange,
the first flange comprises an annular groove configured to be embedded with the first bearing at an inner ring and an outer ring of a circumferential periphery of the connection sleeve,
the third flange comprises an annular groove configured to be embedded with the plug at the inner ring and the outer ring of the circumferential periphery of the connection sleeve,
a portion of the plug protruding out of the connection sleeve cooperates with and passes through an inner hole of the first shaft sleeve to enable the plug to be secured to the first shaft sleeve,
the screw sleeve is encompassed in the connection sleeve and is configured to slide upward and downward, and
the fixed rod is configured to be rotatably and not slidably encompassed in the connection sleeve.

19. The hinge blade structure according to claim 15, wherein:
a circumferential periphery of an outer ring of the damping positioning pull rod comprises a pull rod annular mounting groove,
two ends of the damping positioning pull rod are provided with protruding rings,
a sealing rubber ring inner hole of the sealing rubber ring cooperates with and encompasses the pull rod annular mounting groove of the damping positioning pull rod,
a diameter of the sealing rubber ring extends out of the pull rod annular mounting groove and also extends out of diameters of the protruding rings of the two ends of the damping positioning pull rod,
a size value of the diameter of the sealing rubber ring is larger than an inner diameter of an inner ring of the air cylinder,
the sealing rubber ring disposed on the damping positioning pull rod is configured to abut a wall of the inner ring of the air cylinder, and
the damping positioning pull rod is configured to be hermetically and slidably connected to and abut the inner side of the wall of the air cylinder.

20. The hinge blade structure according to claim 16, wherein:
the adjusting base protruding valve defines a tapered structure, and
the size of the gap is adjusted due to a sliding direction of the adjusting base and the air cylinder along the screw sleeve.

21. The hinge blade structure of claim 12, comprising:
a spring, wherein the spring abuts and is disposed between the screw sleeve and the air cylinder.
